(19) United States
(12) Patent Application Publication
(10) Pub. No.: US 2022/0304331 A1
(43) Pub. Date: Sep. 29, 2022

(54) FIELD BEAN PROTEIN COMPOSITION

(71) Applicant: ROQUETTE FRERES, Lestrem (FR)

(72) Inventors: Damien PASSE, DOUAI (FR); Christophe LAROCHE, FOUGERES (FR); Jorge Luis VENTUREIRA, LILLE (FR)

(21) Appl. No.: 17/593,606

(22) PCT Filed: Mar. 25, 2020
(86) PCT No.: PCT/EP2020/058386

§ 371 Date: Sep. 21, 2021

(30) Foreign Application Priority Data
Mar. 25, 2019 (FR) FR1903099

(51) Int. Cl. A23J 1/14; A23J 3/14; A23L 33/185; A23L 2/66; A23C 11/10; A23L 27/60; A23G 9/38; A23C 9/13

(52) U.S. Cl. CPC A23J 1/14; A23J 3/14; A23L 33/185; A23L 2/66; A23C 11/103; A23L 27/60; A23G 9/38; A23C 9/1315; A23V 2002/00

(57) ABSTRACT

The invention relates to the field of plant protein isolates, and in particular to field bean protein isolates. The invention also relates to a process for the production thereof and to industrial applications thereof.

### TECHNICAL FIELD

The invention relates to the field of plant protein isolates, and in particular to field bean protein isolates.

### BACKGROUND ART

Field beans, or faba beans, are annual plants of the Vicia faba species. These are leguminous plants of the Fabaceae family, Faboideae subfamily, Fabeae tribe.

This is the same species as the broad bean, a plant that has been used for human consumption since ancient times. The word bean thus refers to both the seed and the plant.

Several production methods are known in the background art for producing a protein isolate from field bean seeds.

“Potential of Fava Bean as future protein supply to partially replace meat intake in the human diet.” (Multari & al., in Comprehensive Reviews in Food Science and Food Safety Vol.14, 2015) offers an excellent review of current knowledge on this subject.

The conventional method starts with grinding the field beans in order to obtain a flour. This flour is then diluted in water in order to undergo an alkaline extraction aimed at solubilizing the field bean proteins. The solution then undergoes a liquid/solid separation in order to obtain a crude protein solution and a solid fraction enriched with starch and fiber. The proteins are extracted via precipitation at isoelectric pH of the proteins, they are separated from the aqueous solution and dried.

The protein isolate thus obtained has a protein content of at least 80% (expressed as total nitrogen multiplied by the coefficient 6.25, on the total solids, calculation method disclosed in the document available at the following address http://www.favv-afsca.fgov.be/laboratories/methods/fasfc/_documents/METLFSAL003Protein ebrutevl0.pdf). This isolate has been known to be of industrial interest for a long time, especially in human and animal nutrition. Indeed, its nutritional and functional properties allow it to be included in a large number of recipes and formulations.

However, two major technical problems remain which a skilled person must still face today.

First of all, the protein isolate obtained is systematically characterized by a dark gray, or even black, color. This comes mostly from the tannins and polyphenols present in the external fibers, extracted along with the proteins during the method for manufacturing said protein isolate.

Despite taking extreme care, conventional methods for dehulling the external fiber do not allow enough tannins and polyphenols to be removed, and the apparent dark color limits the number of possible uses.

Optimized methods have been developed. The method disclosed for example in “Technological-scale dehulling process to improve the nutritional value of faba beans” (Meijer & al., in Animal Feed Science and Technology, 46, 1994) includes two grinding steps, two filtering steps and a turbo-separation (classification of particles according to their density using an ascending air flow). These technological refinements are complex and thus costly.

Since the tannins et polyphenols are soluble at alkaline pH, one strategy also consists of not performing the alkaline extraction cited hereinbefore. Unfortunately, if the solubilization of these compounds is thus limited and makes it possible to limit the dark coloration, the extraction yield is greatly limited. Indeed, since field bean proteins are more soluble at alkaline pH, an extraction at neutral or acid pH limits the extraction yield.

Secondly, the field bean protein isolate according to the background art has a water retention of less than 3 grams per gram of proteins. Water retention consists of measuring the amount of water that the protein isolate can absorb after being exposed to an aqueous solvent under conditions defined in the Test A, disclosed in detail in the following pages of this description.

For example, in the article “Nutritional and functional properties of Vicia Faba protein isolates related fractions.” (Vioque, Food Chemistry, 132, 2012), the water retention capacity of the isolate is of 2.55 grams per gram of proteins (cf. table 3 of the article). Likewise, in “Composition and functional properties of protein isolates obtained from commercial legumes grown in northern Spain” (Fernandez-Quintela, in Plant Foods for Human Nutrition, 51,1997), the water retention capacity of the isolate is of 1.8 grams per gram of protein (cf. table 4 of the article).

These values suitable for certain industrial applications can be limiting for others.

It is therefore technically interesting to know a simple and effective method that makes it possible to obtain a field bean isolate with the lightest possible color and having a water retention greater than 3 grams of water per gram of isolate.

The applicant deserves recognition for having found such a method and such an isolate. This invention will be disclosed in the following section.

### DESCRIPTION OF THE INVENTION

The present invention relates to a field bean protein composition the color of which is characterized by a component L greater than 70 according to the measurement L*a*b and the water retention is greater than 3 grams of water per gram of isolate.

According to another aspect, the invention relates to a method for producing a field bean protein composition according to the invention, characterized in that it comprises the following steps: 1) Using field bean seeds; 2) Grinding the field bean seeds by means of a stone mill, followed by separating the obtained ground material into two fractions referred to as light and heavy by means of an ascending air flow, followed by second grinding of the heavy fraction with a knife mill; 3) Finally grinding the heavy fraction by means of a roller mill to obtain a flour; 4) Suspending the flour in an aqueous solvent; 5) Removing the solid fractions from the suspension by centrifugation and obtaining a liquid fraction; 6) Isolating by precipitation by heating at the isoelectric pH of the field bean proteins contained in the liquid fraction; 7) Diluting the field bean proteins previously obtained to 15-20% by weight of solids and neutralizing the pH between 6 and 8, preferentially 7, to obtain the field bean protein composition; 8) Drying the field bean protein composition.

According to a final aspect, the invention relates to industrial uses, in particular in human or animal nutrition, in cosmetics, in pharmacy, of the field bean protein isolate according to the invention.

The invention and the variants thereof can make it possible, typically, to propose a practical and efficient solution for meeting the needs of the industry to have a field bean protein isolate the color of which is characterized by a component L greater than 70 according to the measurement L*a*b and the water retention is greater than 3 grams of water per gram of isolate, the method for producing same and the ideal industrial uses thereof.

The invention will be better understood with the aid of the description, presented in the following chapters.

### BRIEF DESCRIPTION OF THE DRAWINGS

Other features, details and advantages of the invention will appear from reading the following detailed description, and by analyzing the appended drawings, in which:

FIG. 1 shows a conventional method for separating the external fibers and the cotyledons of field beans;

FIG. 2shows a method according to the invention for separating the external fibers and the cotyledons of field bean seeds;

### DETAILED DESCRIPTION OF THE INVENTION

As mentioned above, the present invention first relates to a field bean protein composition the color of which is characterized by a component L greater than 70, preferably greater than 75, even more preferentially greater than 80 according to the measurement L*a*b and the water retention according to the test A is greater than 3 grams, preferentially greater than 3.5 grams of water per gram of isolate.

“Field bean” is intended to mean the group of annual plants of the species Vicia faba, belonging to the group of leguminous plants of the Fabaceae family, Faboideae subfamily, Fabeae tribe. A distinction is made between Minor and Major varieties. In the present invention, wild-type varieties and those obtained by genetic engineering or varietal selection are all excellent sources.

“Protein composition” is understood to mean any protein-rich composition, obtained by extraction of a plant and purification if need be. A distinction is made between the concentrates in which the richness expressed as a % of proteins to solids is greater than 50%, and the isolates in which the richness expressed as a % of proteins to solids is greater than 80%.

“Measurement L*a*b” is understood to mean the evaluation of the coloring according to the chromatic space methodology of the CIE (International Commission on Illumination) presented in the publication “Colorimetry” (no. 15, 2nd edition, page 36, 1986), by means of a suitable spectrophotometer, which converts it into 3 parameters: the lightness L, which takes values between 0 (black) and 100 (reference white); the parameter a represents the value on a green→red axis and the parameter b represents the value on a blue→yellow axis. The measurement of this coloring is preferentially performed using the spectrophotometers DATA COLOR-DATA FLASH 100 or KONIKA MINOLTA CM5, with the aid of their user manuals.

“Water retention” is understood to mean the amount of water in grams that one gram of protein is able to absorb.

In order to measure the water retention capacity, test A is used, the protocol of which is disclosed below.

Weigh 20 g of sample to be analyzed in a beaker, add drinking water at room temperature (20° C. +/−1° C.) until completely submerging the sample, leave in static contact during 30 minutes, separate the residual water and the sample using a sieve and weigh the final rehydrated weight P of the sample in grams.

The following calculation is then applied to obtain the water retention capacity (in g)=(P−20)/20

Preferably, the isolate according to the invention is characterized in that its protein content is greater than 70% expressed as a weight percentage of protein on solids, preferably greater than 80% by weight, even more preferably greater than 90% by weight.

Preferably, the protein composition according to the invention has a solids content greater than 80% by weight, preferably greater than 85% by weight, even more preferably greater than 90% by weight. Any method for measuring water content can be used to quantify these solids, the gravimetric technique evaluating water loss through drying being preferred. It consists in determining the amount of water evaporated by heating a known amount of a sample of known weight.
The sample is first weighed and a mass m1 is measured in grams.
The water is evaporated off by placing the sample in a heated chamber until the mass of the sample has stabilized, the water being completely evaporated off. Preferably, the temperature is 105° C. at atmospheric pressure
The final sample is weighed and a mass m2 is measured in grams
Solids=(m2/m1) * 100.

A second aspect of the invention consists of a method for producing a field bean protein composition according to the invention, characterized in that it comprises the following steps: 1) Using field bean seeds; 2) Grinding the field bean seeds by means of a stone mill, followed by separating the obtained ground material into two fractions referred to as light and heavy by means of an ascending air flow, followed by second grinding of the heavy fraction with a knife mill; 3) Finally grinding the heavy fraction by means of a mill selected from roller mills and knife mills to obtain a flour; 4) Suspending the flour in an aqueous solvent; 5) Removing the solid fractions from the suspension by centrifugation and obtaining a liquid fraction; 6) Isolating by precipitation by heating at the isoelectric pH of the field bean proteins contained in the liquid fraction; 7) Diluting the field bean proteins previously obtained to 15-20% by weight of solids and neutralizing the pH between 6 and 8, preferentially 7, to obtain the field bean protein composition; 8) Drying the field bean protein composition.

“Stone mill” is understood to mean a system made up of two superimposed stone cylinders leaving a space equal to the size of the seed. One of the cylinders is static, while the other is rotating. The seeds are inserted between these two cylinders, and their relative movement imposes physical stress on these seeds.

“Knife mill” should be understood to mean a system consisting of a chamber equipped with an upper inlet for inserting the seeds, several knives arranged on a shaft intended to rotate them inside said chamber and a lower outlet equipped with a sieve to let out only the seeds with a desired particle size.

The first step consists of using field bean seeds. These seeds still comprise their protective external fibers, also referred to as hulls. The seeds may undergo a pre-treatment which can comprise steps of cleaning, sieving (for example, for separating seeds and stones), soaking, bleaching, toasting. Preferably, if bleaching is performed, the heat treatment scale will be 3 minutes at 80° C. Nonlimiting examples of varieties are Tiffany, FFS or YYY. Preferentially, field bean seed varieties will be used that have a naturally low tannin or polyphenol content, such as the Organdi variety. Such varieties are known and can be obtained by varietal crossing and/or genetic modification.

The second step relates to the most effective possible separation of the external fibers and the cotyledons. It begins with a first grinding of the field bean seeds using a stone mill. A specific, particularly appropriate example of such a stone mill is, for example, marketed by the company Alma®. As previously disclosed, the seed is inserted into a space formed by two stone discs, one of which is rotating. The applicant has noticed that this technique is particularly interesting since it produces a highly effective separation of the external fibers and the cotyledons of the seeds. Preferably, the inter-disc space is adjusted between 0.4 and 0.6 mm.

The ground material is then subjected to a counter-current ascending air flow. The various solid particles are classified according to their density. Typically, after equilibrium, two fractions are obtained: a light fraction containing mostly the external fibers or hulls and a “heavy” fraction containing mostly the cotyledons. A specific, particularly appropriate example of an adequate apparatus is for example the MZMZ 1-40 marketed by the company Hosokawa-alpine®.

The heavy fraction, enriched in cotyledons, is then ground using a knife mill. A specific, particularly appropriate example of such a knife mill is for example the SM300 marketed by the company Retsch®.

The succession of the three operations cited hereinbefore in the second step aims to separate very finely the external fibers and the cotyledons, avoiding damaging these two parts and mixing them. The methods of the background art are either too simplistic, and do not manage to effectively separate the external fibers, or are complicated and thus difficult to operate from an industrial viewpoint. The method disclosed for example in “Technological-scale dehulling process to improve the nutritional value of faba beans” (Meijer & al., in Animal Feed Science and Technology, 46, 1994) includes two grinding steps, two filtering steps and one turbo-separation (by an ascending air flow). This method makes it possible to obtain a cotyledon fraction that still contains 1.2% of external fibers in the cotyledons. Our invention simplifies the method (two grinding steps using types of mills with different technologies, with a turbo-separation between the two grinding steps) and makes it possible to reduce the external fiber content to a value of 1%, or less.

The third step aims to reduce the particle size of the heavy fraction enriched with cotyledons by grinding same using a mill selected among the roller mills and the knife mills, particularly a roller mill. A specific, particularly appropriate example, for so-called “dry” grinding, i.e. without solvent, of such a roller mill is for example the MLU 202, marketed by the company Bühler®.It is used herein in order to reduce the overall particle size of the flour, in order to obtain a uniform, sufficiently fine powder so as to facilitate the following step 4. The preferred particle size is comprised between 200 and 400 microns, preferentially 300 microns. In order to measure this particle size, a laser particle size analyzer is preferably used, although any method is possible, such as sieving.

Alternatively, the step of reducing the particle size of the heavy fraction enriched with cotyledons, also referred to final grinding of the heavy fraction, can be carried out in the presence of aqueous solvent, preferentially water. In this case, the fourth step below is merged with the third step which are then performed concomitantly. In this case, a suitable grinder is for example the Hurschel® Comitrol 3000 knife mill.

The fourth step aims to place the powder obtained in the preceding third step in suspension in an aqueous solvent, preferentially in water. The aim here is to perform a selective extraction of certain components, mostly the proteins as well as the salts and the sugars, by solubilizing them. The pH of the solution is advantageously rectified towards an alkaline pH in order to maximize the protein solubilization. This pH rectification can be carried out before and/or after suspending the powder in the aqueous solvent.

The aqueous solvent is preferentially water. The latter may, nevertheless, contain additives, for example with compounds that make it possible to facilitate the solubilization. The pH of the aqueous solvent is adjusted between 8 and 10, preferentially 9. Any basic reagent such as soda, lime, is possible, but potash is preferred. The temperature is adjusted between 2° C. and 30° C., preferentially between 10° C. and 30° C., preferentially between 15° C. and 25° C., even more preferentially to 20° C. This temperature is controlled throughout the entire extraction reaction.

The alkaline pH is effective for maximizing protein solubilization. Unfortunately, the tannins and/or polyphenols are also solubilized at an alkaline pH. Certain field bean extraction methods avoid this rectification to basic pH, favoring a reduction in yield over polyphenol contamination. Our specific method carried out in the second step makes it possible to perform this alkaline extraction, without excessively solubilizing the polyphenols.

The powder obtained is diluted in order to obtain a suspension comprised between 5% and 25%, preferentially between 5% and 15%, preferentially between 7% and 13%, even more preferentially between 9% and 11%, the most preferred being 10%, the percentage being expressed as a percentage of powder by total weight of the water/powder suspension. The suspension is stirred using any apparatus known to a skilled person, for example a vat provided with a stirrer, provided with blades, marine propellers or any equipment that allows effective stirring. The extraction time, preferentially while stirring, is comprised between 5 and 25 minutes, preferentially between 10 and 20 minutes, even more preferentially 15 minutes.

The fifth step aims to separate by centrifugation the soluble fraction and the solid fraction obtained during the fourth step. The preferred industrial principle can be found in patent application EP1400537, which is incorporated herein by reference. The principle of this method is to start by using a hydrocyclone in order to extract a fraction enriched with starch, then to use a horizontal decanter in order to extract a fraction enriched with internal fibers. Nevertheless, it is possible to use an industrial centrifuge which extracts a fraction enriched with starch and internal fibers. In every case, solid fractions and a liquid fraction that concentrates most of the proteins are obtained.

The sixth step aims to acidify to the isoelectric pH of the field bean proteins, around 4.5, and then to subject the solution to heating in order to coagulate the proteins referred to as globulins, which are separated by centrifugation.

The acidification is carried out to a pH between 4 and 5, preferentially 4.5. This is preferentially done with hydrochloric acid at about 7% by weight, but all types of acids, mineral or organic, can be used such as citric acid. Even more preferentially, the use of pure ascorbic acid or ascorbic acid in combination with another mineral or organic acid, is also possible. The use of ascorbic acid to acidify helps improve the final coloring. Any heating means is then possible, for example by means of a stirred vat provided with a double shell and/or coil or an in-line steam-injection cooker (“jet cooker”). The heating temperature is advantageously between 45° C. and 75° C., preferentially between 50° C. and 70° C., even more preferentially between 55° C. and 65° C., the most preferred being 60° C. The heating time is between 5 minutes and 25 minutes, preferentially between 10 and 20 minutes, the most preferred being 10 minutes.

The protein composition, mostly globulin, coagulates and precipitates within the solution. It is separated by any centrifugation technique, for example such as the Flottwegg® Sedicanter. The residual solution obtained concentrates sugars, salts and albumins, it is referred to as field bean solubles. It is processed separately, preferentially evaporated and/or dried.

It should be noted that the background art of field bean protein extraction exclusively teaches isoelectric precipitation, without heating. The combination of the two steps according to the invention makes it possible to obtain the isolate according to the invention, but also to obtain field bean solubles (name of the supernatant obtained after precipitation and centrifugation) which are temperature-stable. Indeed, the field bean solubles obtained by isoelectric precipitation when they are exposed to a high temperature, for example in an evaporator, precipitate. This precipitation is a major drawback since is leads to soiling of industrial facilities.

Conversely, the combination of isoelectric precipitation with controlled heating proposed by the invention makes it possible to obtain:
a floc of coagulated proteins, resulting after the required treatment in the product claimed in the present application, and
residual solubles containing among others soluble proteins (albumins), salts and sugars

The second fraction can typically be reused in the fermentation and/or animal nutrition industries. For this purpose, it should be concentrated in order to be stabilized in bacteriological terms. For this purpose, an operation for concentration by evaporation under vacuum is conventional, carried out by means of a second heating step distinct from the one that allowed the coagulation of the floc. During this operation, and in the case of simple isoelectric precipitation during floc/soluble separation, a deposit of coagulated proteins builds up in the evaporator.

In a seventh step, the protein composition is then diluted to around 15-20% by weight of solids and neutralized to a pH comprised between 6 and 8, preferentially 7, by means of any basic agent, preferentially potash at 20% by weight.

The protein composition can then undergo a thermal treatment, preferentially at a temperature of 135° C. by direct steam injection through a nozzle and flash vacuum cooling to 65° C.

The protein composition obtained can be used directly for example by being hydrolyzed by a protease or else texturized by an extruder.

In an eighth step, the protein composition according to the invention is dried. The preferred drying mode is atomization, in particular using a multiple-effect atomizer. The typical parameters are an input temperature of 200° C. and a vapor temperature of 85-90° C.

According to a final aspect, the invention relates to industrial uses, in particular in human or animal nutrition, in cosmetics, in pharmacy, of the field bean protein isolate according to the invention. The field bean composition obtained according to the invention has a very high protein content as well as a very white color, thus allowing it to be included in a considerable number of recipes, including in particular beverages, in particular plant-based milk analogues. Moreover, as will be exemplified hereinafter, the protein composition according to the invention has an inhibitory action on DPP-IV which allows it to provide a satiating effect when consumed.

More particularly, the invention relates to the use of the field bean isolate in nutritional formulations such as:
beverages, particularly via mixtures of powders to be reconstituted, particularly for dietary nutrition (sports, slimming), ready-to-drink beverages for dietary or clinical nutrition, liquids (enteral beverages or bags) for clinical nutrition, plant beverages,
fermented milks such as yoghurt (blended, Greek, drinkable, etc.)
plant creams (such as coffee creamer or whitener), dessert creams, frozen desserts or sorbets.
biscuits, muffins, pancakes, nutritional bars (intended for specialized nutrition for slimming or for athletes), bread, particularly high-protein gluten-free bread, high-protein cereals, obtained by extrusion cooking (“crisps” for inclusion, breakfast cereals, snacks),
cheese,
meat analogues, fish analogues, sauces, in particular mayonnaise.

The isolate according to the invention is of interest for yoghurts. Yoghurt, yogurt or yoghourt is milk inoculated with lactic ferments in order to thicken it and preserve it for longer. In order to be called yoghurt, it must necessarily include only two specific ferments, Lactobacillus delbrueckii subsp. bulgaricus and Streptococcus thermophilus, which provide its specific flavor qualities, its texture and also provide certain nutritional and health benefits. Other fermented milk products (with the same texture as yoghurt) have been created in recent years. They may or may not contain these two bacteria, and may also contain strains such as Lactobacillus acidophilus, Lactobacillus casei, Bifidobacterium bifidum, B. longum, B. infantis and B. breve. Yoghurt is an excellent source of probiotics, i.e. living microorganisms which, when ingested in sufficient quantities, have positive effects on health, beyond their conventional nutritional effects. Whether set, blended or liquid, it still keeps the name yoghurt, since it is actually, aside from the definitions of the Regulations, its production which conditions its final texture. Thus, to obtain a set yoghurt, the milk is inoculated directly in the pot. Meanwhile, in the case of blended yoghurt (also referred to as “Bulgarian”), the milk is inoculated in a vat, and then blended before being poured into its pot. Finally, liquid yoghurt, also referred to as drinking yoghurt, is blended and then whisked to obtain the adequate texture and poured into bottles. However, there are also other types of plain yoghurts, such as Greek yoghurts, with a thicker texture. The fat content can also affect the texture of yoghurt, which can be made from whole, semi-skimmed or skimmed milk (a label that only comprises the word “yoghurt” necessarily denotes a yoghurt produced using semi-skimmed milk). In every case, its expiry date cannot exceed 30 days and it must always be kept in the refrigerator between 0° and 6°.

Thus, there are three main classes of yoghurt:
Stirred yoghurt: More liquid, it is often sourer than plain yoghurt. Only its texture is different. It is also referred to as Bulgarian yoghurt—in reference to the supposed origin of yoghurt and to Lactobacillus bulgaricus, one of the ferments used to transform milk into yoghurt. It is manufactured in a vat and then packaged in pots. It is particularly suited to the production of beverages such as lassis, fruit cocktails, etc.
Greek yoghurt: Particularly thick, this is a plain yoghurt that is strained (traditional technique) or enriched with cream. Gourmet, very tasty, it is essential for the production of tzatziki and for all Eastern European dishes, and it makes a delicious dip appetizer when simply mixed with fine herbs. When cold, it can substitute thick creme fraiche,
Drinking yoghurt: While it does exist plain, it is most often sweetened and flavored, and manufactured with a whisked, blended yoghurt. Invented in 1974, it allowed teenagers to rediscover the pleasure of milk, drinking yoghurt without a spoon, direct from the bottle. A recent development is “pouring yoghurt”, in a 950 g carton, for those who want to combine cereal with yoghurt for their breakfast. Low in energy—from 52 kcal for a 0% yoghurt made from skimmed milk to 88 kcal for a yoghurt made from whole milk—“plain” yoghurt is naturally low in fat and carbohydrates, but contains an interesting amount of protein. It is also a source of micronutrients (particularly calcium and phosphorus) as well as vitamins B2, B5, B12 and A. Made up of 80% water, yoghurt plays an active role in hydrating the body.

Regular yoghurt consumption is also recommended in order to improve digestion and lactose absorption (EFSA notice of 19 Oct. 2010). Other studies show potential benefits for alleviating diarrhea in children, and for improving the immune system in certain persons such as the elderly. However, cow milk consumption is increasingly criticized and called into question and rising numbers of people are deciding to simply eliminate it from their diets, for example for reasons of lactose intolerance or allergy problems. Yoghurt solutions made from plant milk have thus been proposed, since plant milks are much easier to digest than cow milk and are rich in vitamins, minerals and unsaturated fatty acids. Hereunder, for the sake of simplicity, we will continue to use the term “yoghurt” even if the origin of the protein is not dairy (officially, “yoghurts” that are made from ingredients other than fermented milk, dairy ingredients, or conventional ferments such as Lactobacillus delbrueckii subsp. bulgaricus and Streptococcus thermophilus are not entitled to use this name). The most common plant source is soy. However, even though soy milk has the highest levels of calcium and proteins, it is also very hard to digest, which is why it is not recommended for children. In addition, it is no longer considered advisable to overuse soy-based products since their health effects may be counterproductive when consumed in large amounts. Furthermore, it is commonly acknowledged that 70% of soy production worldwide is GMO.

The isolate according to the invention is also of interest for milk and dairy beverages as well as for plant beverages. Milk is a foodstuff that contains a considerable source of high-quality proteins. For a long time, animal proteins have been praised for their excellent nutritional qualities because they contain all the essential amino acids in the right proportions. However, some animal proteins may produce allergies, causing very harmful reactions, which may even be dangerous in everyday life. Dairy allergies are among the most widespread allergic reactions. Studies show that 65% of people who suffer from food allergies are allergic to milk. The adult form of milk allergy, referred to herein as “dairy allergy”, is a reaction of the immune system which creates antibodies to fight the unwanted food. This allergy is different from cow milk protein allergy, also referred to as CMPA, which affects infants and children. The clinical manifestations of this allergy are mainly gastro-food (50 to 80% of cases), also cutaneous (10 to 39% of cases) and respiratory (19% of cases). In view of all the disadvantages cited above associated with the consumption of dairy products, there is great interest in using substitution proteins, also referred to as alternative proteins, which include plant proteins. Plant milks, obtained from plant ingredients, can be an alternative to animal milks. They alleviate and avoid CMPA. They are free of casein, lactose, cholesterol, are rich in vitamins and minerals, are also rich in essential fatty acids but low in saturated fatty acids. Some of them also have interesting fiber contents. In addition to the fact that certain plant milks are low in calcium, that others due to their botanical rarity are unavailable commercially, it should also be mentioned that certain plant milks are also allergenic. This is the case, for example, with plant milks prepared from oilseeds, such as soy milks. In view of all the disadvantages of dairy proteins, but also the dangerous allergenic nature of certain plant proteins, there is a real demand from consumers, which has not yet been met, for plant milks that are indisputably and recognizably safe and can therefore be consumed by the whole family. Traditional manufacturers are also starting to look for new protein sources to enrich their products.

The isolate according to the invention is also interesting for dairy creams for coffee creamer, butter, cheese, Chantilly creams, sauces, toppings, cake decoration. Dairy creams are products with a fat content of more than 30% obtained by concentrating milk, presented in the form of an emulsion of oil droplets in skimmed milk. They can be used for various applications, either directly as a consumer product (for example when used as coffee creamer) or as raw material for the production of other products such as butter, cheese, Chantilly creams, sauces, ice creams, or even cake toppings and decorations. There are different varieties of cream: fraiche, light, single, thick, pasteurized. Creams can be distinguished according to their fat content, their conservation and their texture. Raw cream is the cream resulting from the separation of the milk and the cream, directly after skimming and without passing through the pasteurization step. It is liquid and contains 30 to 40% fat. Also with liquid texture, pasteurized cream has undergone a pasteurization process. It has thus been heated to 72° C. during around twenty seconds in order to remove microorganisms that are harmful to humans. This cream is particularly well suited to whipping. It takes on a lighter, more voluminous texture when it is whisked to incorporate air bubbles. It is perfect for Chantilly cream for example.

Some single creams sold in stores are said to have a long shelf life. They can be stored for several weeks in a cool, dry place. In order to keep for so long, these creams are either sterilized or heated according to the UHT method. Sterilization involves heating the cream during 15 to 20 minutes to 115° C. With the UHT (Ultra High Temperature) method, the cream is heated during 2 seconds to 150° C. The cream is then rapidly cooled, which has the result of better preserving its gustatory qualities. Cream is naturally liquid, once it has been separated from the milk, after skimming. In order for it to adopt a thick texture, it passes through the inoculation step. Lactic ferments are thus added which, after ripening, give the cream this thicker texture and this sourer, richer flavor. In addition to traditional technologies (millennia or centuries old) for obtaining cream from milk, technologies for assembling or reconstituting cream from dairy ingredients have been developed over the last decade. These novel technologies for reconstituting dairy creams have obvious advantages in industrial methods, compared to fresh cream: low cost of raw material storage, greater formulation flexibility, independence from the seasonal composition of milk. Also, reconstituted dairy creams can benefit from the image of naturalness generally attributed to dairy products, since regulations require for their manufacture the exclusive use of dairy ingredients with or without the addition of drinking water and the same finished product characteristics as milk cream (Codex Alimentarius, 2007). The development of the field of reconstituted dairy creams has opened up new possibilities in the formulation of creams, and more particularly the birth of the concept of plant creams. Plant creams are products similar to dairy creams in which the milk fat is replaced with plant fat (Codex Alimentarius, codex Stan 192, 1995). They are formulated using well-defined amounts of water, plant fats, milk or plant proteins, stabilizers, thickeners and low molecular weight emulsifiers. The physico-chemical parameters, such as particle size, rheology, stability and suitability for whipping are the characteristics that are of primary interest to industrialists and researchers in the field of the substitution of dairy creams by plant creams. For example, as in any emulsion, the size of the dispersed droplets (particle size) is a key parameter in the characterization of creams because it has a significant impact, on the one hand, on other physico-chemical properties such as rheology and stability, and on the other hand, on sensory properties such as the texture and the color of creams. The influence of the type of emulsifier includes both low molecular weight emulsifiers such as mono, diglycerides and phospholipids, and high molecular weight emulsifiers such as proteins, as well as protein/low molecular weight emulsifier interactions. It is thus known that the concentration of the lipid emulsifier also influences the droplet size of the creams. In protein-stabilized systems, a very high concentration of lipid emulsifier can lead to a strong increase in the average droplet size, due to a strong aggregation of the droplets following the desorption of the proteins. The type of proteins used in the formulation can also affect the particle size of the creams. Indeed, under the same emulsification conditions, creams based on casein-rich protein sources, such as skim milk powder, generally have smaller average droplet diameters than those based on whey-rich protein sources, such as whey powder. The differences in particle size between the creams prepared from the two protein sources (caseins or whey proteins) are related to the differences in interfacial properties at the oil/water interface, caseins having a greater capacity to lower the interfacial tension than whey proteins. Furthermore, the protein concentration in the formulation affects the particle size of the creams. Indeed, it has been proven that with a constant oil mass fraction, the droplet size decreases with the protein concentration until a certain concentration beyond which the size varies very little. The simultaneous presence of low molecular weight (surfactant) and high molecular weight (proteins) amphiphilic molecules in a cream formulation generally results in a decrease in droplet size during emulsification. Furthermore, the competitive adsorption at the oil/water interface between surfactants and proteins generally leads to a desorption of proteins from the surface of the droplets during the ripening process, which can lead to particle size changes.

Initially, it appears that the emulsification conditions, the choice of ingredients (both protein and lipid) used in the formulation, as well as the temperature, influence the final properties of the creams. It appears that plant creams can lead to new technical and functional properties. Thus, the freeze resistance that can provide great stability to ice cream is one example. They can also be stable in hot or cold binding, which is a considerable advantage, since these creams can be used indifferently in the preparation of hot or cold dishes. While plant creams can bring new functionalities and display textural properties comparable to or even more interesting than those of dairy creams, it remains that they can present sensory defects, in particular in relation to their taste and smell, even sometimes after the addition of flavors (which is the case of soy proteins, or pea proteins).

The isolate according to the invention is also of interest for plant cheeses. Cheese is normally a foodstuff obtained from clotted dairy milk or cream, which is strained and then optionally fermented, and eventually aged. Cheese is thus made from cow milk mainly, but also from the milk of sheep, goat, buffalo or other mammals. The milk is acidified, generally by means of a bacterial culture. An enzyme, pressure or a substitute such as acetic acid or vinegar is then added in order to cause the clotting and to form the curds and the whey. It is known to produce vegan cheese alternatives (especially mozzarella-type cheeses), by substituting the milk caseinates with native and modified starches, especially acetate stabilized starches. However, it is still sought to improve the “shredability”, the melting, the stability to freezing/thawing, the flavor (especially in the United States for pizza preparations). Trials have been conducted with a combination of oil, modified starches and pea proteins without complete satisfaction.

The isolate according to the invention is of interest for ice creams. Ice creams conventionally contain animal or plant fats, proteins (milk proteins, egg proteins) and/or lactose. The proteins thus act as a texturizer while also adding flavor to the ice cream. They are essentially produced by weighing the ingredients, pre-mixing them, homogenizing them, pasteurizing them, refrigerating them at 4° C. (allowing ripening), and then freezing them before packaging and storage. However, many people suffer from intolerance to dairy products or other animal ingredients that prevent them from consuming milk or traditional ice cream. For this consumer group, there is currently no alternative to ice cream containing milk that has a comparable sensory value. In the ice cream preparations known until now using plant ingredients, mainly soy-based, attempts have been made to replace the animal emulsifiers with plant proteins. Dried plant proteins, obtained in the conventional methods of aqueous or hydroalcoholic extraction and after drying in powder form, have often been used. These proteins turn out to be heterogeneous mixtures of polypeptides, some fractions of which have particularly good properties to varying degrees as emulsifiers or gel-forming agents, as water-binding agents, foam-forming agents or texture-improving agents. Until now, plant protein products have been obtained almost exclusively from soybeans, without fractionation according to their specific functional properties. Moreover, the taste of the ice creams prepared with such soy proteins is unacceptable.

The isolate according to the invention is of interest for cookie products, pastry products, bread products and high-protein cereal products. In order to reach a “high-protein” claim, according to current regulations, the calorie content associated with the proteins must be equal to or greater than 20% of the total energy content of the finished product. This means that, in products with high fat content such as cookies or cakes (between 10% for the leanest and 25% for the richest, with an average fat content of 18%), the incorporation rate of proteins to reach the claim is considerable and is higher than 20%.

In the field of the substitution (total or partial) of dairy proteins in food products, plant proteins with functional properties that are equivalent or even improved compared to dairy proteins are sought. The term “functional properties” in this application means any non-nutritional property that influences the usefulness of an ingredient in a food product. These various properties contribute to obtaining the desired final characteristics of the dairy product. Some of these functional properties are solubility, viscosity, foaming properties, emulsifying capacities. Proteins also play an important role in the sensory properties of the food matrices in which they are used, and there is real synergy between the functional and sensory properties. The functional properties of proteins or functionalities are therefore the physical or physico-chemical properties that affect the sensory qualities of food systems generated during technological processing, preservation or household culinary preparations. Regardless of the origin of the protein, it can be seen to affect the color, flavor and/or texture of a product. These organoleptic characteristics play a decisive role in the consumer's choice and in this case are largely taken into account by the manufacturers. The functionality of proteins is the result of their molecular interactions with their environment (other molecules, pH, temperature, etc.). Here, we are talking about surface properties which include the interaction properties of proteins with other polar or apolar structures in the liquid or gas phase: this includes emulsifying properties, foaming properties, etc.

Within human food applications, the protein composition according to the invention is particularly suitable for dairy applications. More particularly, the invention relates to the use of the field bean isolate according to the invention for fermented milks like yoghurt (blended, Greek, drinkable) and in dairy or plant creams, dessert creams, ice cream desserts or sorbets or in cheeses.

The nutritional formulations according to the invention may further comprise other ingredients that may modify the chemical, physical, hedonic or processing characteristics of the products or serve as pharmaceutical or complementary nutritional components when used for a certain target population. Many of these optional ingredients are known or otherwise suitable for use in other food products and may also be used in the nutritional formulations according to the invention, provided that these optional ingredients are safe and effective for oral administration and are compatible with the other essential ingredients of the selected product. Non-limiting examples of such optional ingredients comprise preservatives, antioxidants, emulsifying agents, buffering agents, pharmaceutical active agents, additional nutrients, colorants, flavors, thickening agents and stabilizers, etc. The powdered or liquid nutritional formulations may further comprise vitamins or nutrients such as vitamin A, vitamin E, vitamin K, thiamine, riboflavin, pyridoxine, vitamin B12, carotenoids, niacin, folic acid, pantothenic acid, biotin, vitamin C, choline, inositol, their salts and derivatives, and combinations thereof. The powdered or liquid nutritional formulations may further comprise minerals, such as phosphorus, magnesium, iron, zinc, manganese, copper, sodium, potassium, molybdenum, chromium, selenium, chloride, and combinations thereof. The powdered or liquid nutritional formulations may also comprise one or more masking agents to reduce, for example, bitter flavors in reconstituted powders. Suitable masking agents comprise natural and artificial sweeteners, sodium sources such as sodium chloride, and hydrocolloids such as guar gum, xanthan gum, carrageenan, and combinations thereof. The amount of masking agent in the powdered nutritional formulation may vary depending on the particular masking agent selected, the other ingredients in the formulation, and other formulation or target product variables.

Said invention will in particular be better understood from reading the following examples.

### EXAMPLES

### Example 1: Comparison of Traditional and Conventional Methods for Dehulling the External Fibers

A single batch of field bean seeds of the Tiffany variety is processed to separate the external fibers and the cotyledons. To do so, two methods are used.

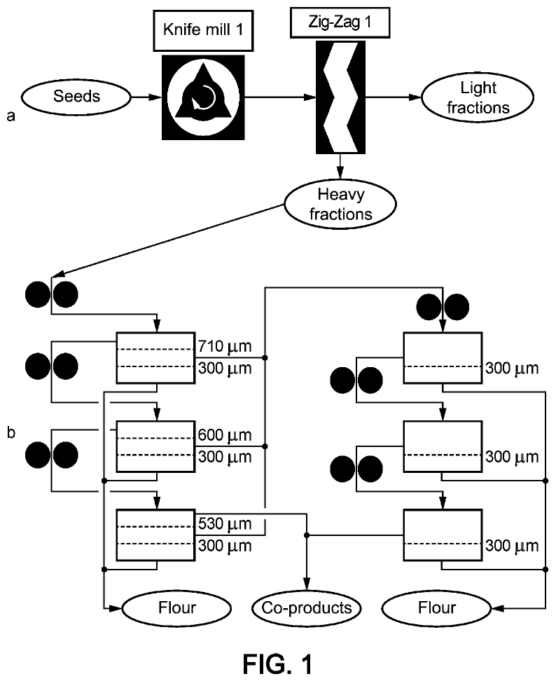

Method of the background art: The seeds are first processed using a knife mill (SM300, Retsch®) with a rotation speed of 700 RPM. The ground material is then processed by turbo-separation using a so-called “zig-zag” system (MZM 1-40, Hosokawa-alpine®). The air speed is 4.0 m.5⁻¹ (23 m³.h⁻¹). At the end a light fraction containing the external fibers and a heavy fraction containing the cotyledons are obtained. The heavy fraction is then ground using a roller mill (MLU 202, Buhler®). At the end a flour is obtained in which the particle size is less than 300 μm (the average particle size measured with a laser particle size analyzer is 275 μm). The method is shown schematically in FIG. 1.

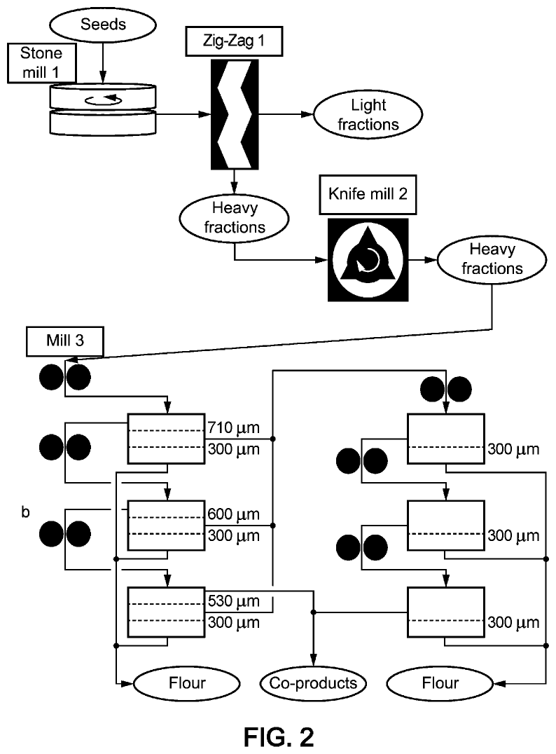

Improved method according to the invention: The seeds are first processed using a stone mill (Alma®). The ground material is then processed by turbo-separation using a so-called “zig-zag” system (MZM 1-40, Hosokawa-alpine®). The air speed is 4.0 m.5⁻¹ (23 m³.h⁻¹). At the end a light fraction containing the external fibers and a heavy fraction containing the cotyledons are obtained. The heavy fraction is then processed using a knife mill (SM300, Retsch®) with a rotation speed of 700 RPM, the outlet of which is fitted with a 6 mm screen. The heavy fraction is then ground using a roller mill (MLU 202, Bühler®). At the end a flour is obtained in which the particle size is less than 300 μm (the average particle size measured with a laser particle size analyzer is 285 μm). The method is schematically shown in FIG. 2.

A manual separation is carried out of the residual external fibers (or hulls) in the heavy fraction obtained according to the two methods of the background art and according to the invention disclosed previously. This consists of taking a 200 g sample of the fraction, and then manually separating any external fibers still present. These are then weighed (Weight=m). The percentage of residual external fibers is given by the following calculation: (m/200) * 100

For the method according to the background art, the percentage is 1.7%. For the method according to the invention, this percentage is reduced to 0.9%.

### Example 2a: Production of a Protein Composition According to the Invention

75 kg of field bean flour is prepared using the improved method according to the invention disclosed in paragraph [0077] hereinbefore. This flour is placed in suspension at 10% by weight of solids in drinking water at 20° C. The pH is adjusted to 9 by adding potash at 20% by weight (3.4 kg). Homogenization is carried out during 15 minutes also at 20° C. The solution is then sent into a Flottweg Sedicanter decanter (bowl speed: 60% or 4657 RPM (around 3500 g), screw speed at 60% for a Vr=18.8, pipette for the supernatant (overflow) at 140 mm, supply at 1 m³/h) and the liquid supernatant containing the proteins is retrieved.

This supernatant is acidified to pH 4.5 by adding hydrochloric acid to around 7% by weight (8.2 kg). It is heated to 60° C. by injecting steam into a double shell of the vat, where homogenization is carried out during 15 minutes. The Flottweg Sedicanter is used a second time (bowl speed at 60%, or 4657 RPM (around 3500 g) screw speed at 10% for a Vr=3.5 up to 40% (Vr=12.6), pipette for the overflow at 140 mm at the start until 137, supply at 700 I/h) but this time in order to retrieve the sediment that contains the coagulated proteins.

The sediment is diluted to around 15-20% by weight of solids and neutralized to pH 7 by adding potash to 20%. A thermal treatment is performed at 135° C. by means of a nozzle and flash vacuum cooling to 65° C. is carried out. The product is finally atomized (input temperature of 200° C. and vapor temperature of 85-90° C.)

The protein extraction yield from the flour is 86.6%. The protein obtained is named “Protein composition according to the invention”

### Example 2b: Production of a Protein Composition According to the Invention with Wet Grinding

The field bean seeds are first processed using a stone mill (Alma®). The ground material is then processed by turbo-separation using a so-called “zig-zag” system (MZM 1-40, Hosokawa-alpine®). The air speed is 4.0 m.5⁻¹ (23 m³.h⁻¹). At the end a light fraction containing the external fibers and a heavy fraction containing the cotyledons are obtained. The heavy fraction is then processed using a knife mill (SM300, Retsch®) with a rotation speed of 700 RPM, the outlet of which is fitted with a 6 mm screen. The heavy fraction pre-ground using the knife mill is suspended to 20% by weight of solids in drinking water at 20° C. The heavy fraction is then ground using a Hurschel® Comitrol 19300 mill. The pH is adjusted to 9 by adding potash to 20% by weight. Homogenization is carried out during 15 minutes also at 20° C. The solution is then sent into a Flottweg Sedicanter decanter (bowl speed: 60% or 4657 RPM (around 3500 g), screw speed at 60% for a Vr =18.8, pipette for the supernatant (overflow) at 140 mm, supply at 1 m³/h) and the liquid supernatant containing the proteins is retrieved.

This supernatant is acidified to pH 4.5 by adding hydrochloric acid to around 7% by weight. It is heated to 60° C. by injecting steam into a double shell of the vat, where homogenization is carried out during 15 minutes. The Flottweg Sedicanter is used a second time (bowl speed at 60%, or 4657 RPM (around 3500 g) screw speed at 10% for a Vr=3.5 up to 40% (Vr=12.6), pipette for the overflow at 140 mm at the start until 137, supply at 700 I/h) but this time in order to retrieve the sediment that contains the coagulated proteins.

The sediment is diluted to around 15-20% by weight of solids and neutralized to pH 7 by adding potash to 20%. A thermal treatment is performed at 135° C. by means of a nozzle and flash vacuum cooling to 65° C. is carried out. The product is finally atomized (input temperature of 200° C. and vapor temperature of 85-90° C.)

The protein extraction yield from the flour is 87.8%. The protein obtained is named “Protein composition 2b according to the invention”

### Example 3: Production of a Protein Composition According to the Background Art

A teaching by Fernandez-Quintela (Plant Foods for Human Nutrition, 51,1997) is implemented. The field bean seeds are first processed using the method of the background art disclosed in paragraph [0064], then the cotyledons are submerged in water during 10 hours, then dried overnight in a kiln at 25° C. The cotyledons are then ground into a flour of 300 microns on average. This flour is suspended in drinking water with a water-to-flour weight ratio of 1:5 and the pH of the solution is rectified to 9.0 using 1N soda. The solution is stirred during 20 min. The insoluble fraction is separated by centrifugation (4000 g/20 min, 20° C.) and set aside. The pH of the supernatant is adjusted to pH 4.0 with 1N hydrochloric acid and stirred at 20° C. during 20 min. The solution is centrifuged (4000 g/20 min, 20° c), and the pellet is lyophilized. This protein composition is named: “Protein composition according to example 3 according to the background art”

### Example 4: Comparison of the Functionalities and Analyses

The various compositions obtained by virtue of examples 2 and 3 are compared from an analytic (solids and protein content) and functional (water retention capacity according to the test A and coloring L) viewpoint. A commercial field bean protein composition, FAVA BEAN PROTEIN ISOLATE 85% by the company YANTAI T, FULL BIOTECH CO LTD (batch DFCO21606181/C1377) is also acquired, which is representative of the field bean isolates available on the market. Table 1 hereunder summarizes these analyses.

TABLE 1

| | | | | FAVA BEAN |
|---|---|---|---|---|
| | | | | PROTEIN |
| | | | | ISOLATE 85% |
| | Protein | Protein | Protein | by the company |
| | composition | composition | composition | YANTAI T, FULL |
| | according to | according to | according to | BIOTECH CO |
| | example 2a | example 2b | example 3 | LTD (batch |
| | according to | according to | according to the | DFC021606181/ |
| | the invention | the invention | background art | C1377) |
| Solids (as % by | 96 | 95.5 | 94 | 92.9 |
| weight) | | | | |
| Protein content | 92.4 | 88.2 | 81.2 | 88.3 |
| (as protein % | | | | |
| of the solids) | | | | |
| Water retention | 3.7 | 6.3 | 1.7 | 2.3 |
| capacity (in | | | | |
| g/g of protein | | | | |
| composition) | | | | |
| Color L | 82 | 82 | 72 | 70 |

The table shows the exceptional water retention capacity of the protein composition according to the invention: it is much greater than 3 grams per gram of protein, while the protein compositions according to the background art in the best of cases barely exceed 2 grams per gram of protein composition.

An excellent protein content can also be noted, greater than 90% for example 2a.

Example 2b has slightly less protein content (still very high when compared with pea and soy isolates, for example), but its water retention capacity is exceptionally high, three times greater than that of the background art.

### Example 4: Nutritional Interest of the Protein Composition According to the Invention

This example aims to present a particular nutritional advantage of the protein composition according to the invention. For this purpose, the NUTRALYS® commercial pea protein compositions, a TUBERMINE® potato protein composition and a PRODIET® milk protein are used as protein composition of the background art.

First of all, gastric and intestinal digestion of such compositions is simulated in vitro, using the protocol described in “Simulated GI digestion of dietary protein: Release of new bioactive peptides involved in gut hormone secretion” (Caron & al., in Food Research International, Volume 89, Part 1, 2016, Pages 382-390) The proteins undergo hydrolysis with pepsin (1/40 enzyme weight/protein weight, pH 3, 2 h, 37° C.) followed by hydrolysis with pancreatin (1/50 enzyme weight/protein weight, pH 7, 2 h, 37° C.). Then the dipeptidyl peptidase-4 or DPP-IV inhibitory activity of the digestates thus obtained is evaluated. DPP-IV is an enzyme present in cell metabolism, its inhibition leads to a considerable increase in the concentration of glucagon-like peptide-1 or GLP-1 (which is an incretin, i.e. an intestinal hormone, secreted by the L-cells of the ileum in response to a meal). and glucose-dependent insulinotropic peptide or GIP (which is an enterogastrone secreted by the K-cells of the duodenum in the postprandial period, potentiating glucose-stimulated insulin secretion in the pancreas). These two hormones cause an increase in insulin secretion and a decrease in glucagon secretion, a property that improves sugar balance in diabetics.

To perform this evaluation, the following protocol is used, which is an adaptation of the protocol disclosed in “Dipeptidyl peptidase-IV inhibitory activity of dairy protein hydrolysates” (Lacroix & Li-Chan, August 2012, International Dairy Journal 25(2):97-102). In short, 25 μL of the digestates are placed in test tubes, at concentrations ranging from 1.21 mg.mL⁻¹ to 13.89 mg.mL⁻¹, in order to be pre-incubated with 75 μL of Tris/HCl buffer (100 mM, pH 8.0) and 25 μL of DPP-IV (0.018 U.mL⁻¹) at 37° C. during 5 min in a 96-well microplate. The reaction is initiated by the addition of 50 μL of Gly-Pro-p-nitroanilide (1 mM). All the samples and reagents are diluted in a Tris/HCl buffer. The microplate is incubated at 37° C. during 1 h, and the absorbance of the released p-nitroanilide is measured at 405 nm every 2 minutes using a microplate reader (ELx808, Biotek, USA). The DPP-IV inhibition percentage is defined as the percentage of DPP-IV activity, inhibited by a given concentration of a sample (1 mg.mL⁻¹) compared with the response of a control. The graphic of the DPP_IV inhibition percentage is then established based on the final sample concentration. The IC50 is determined in mg/ml as the final sample concentration causing an inhibition of 50% of the activity of the DPP-IV, it is expressed in mg/ml. The lower the value of the IC50, the better the sought inhibitory activity of the sample will be.

The results obtained are as follows:

TABLE 2

| | IC50 (in mg/ml) |
|---|---|
| NUTRALYS S85F | 1.07 |
| TUBERMINE | 1.07 |
| PRODIET F90 WPI | 1.09 |
| Field bean protein composition | 0.54 |
| according to example 2a according to | |
| the invention | |

The inhibitory action of the field bean protein composition according to the invention is excellent: indeed, its IC50 is half that of commercial proteins of the background art.

### Example 5: So-Called “Ready-to-Drink” Beverage or RTD with 7% Protein

A “ready-to-drink” beverage or “RTD” is produced in order to compare the field bean isolates according to the invention (2a) with a NUTRALYS® S85F commercial pea isolate by the company ROQUETTE.

The recipes are presented in table 3 below:

| Amount (in g) | Field bean RTD | Pea RTD |
|---|---|---|
| Drinking water | 90.4 | 89.8 |
| Field bean isolate 2a | 8.1 | |
| (86.6% protein) | | |
| Pea isolate | | 8.7 |
| (85.1% protein) | | |
| Sunflower oil | 1.5 | 1.5 |

The method for preparing the beverages is as follows:
Mix the various powders
Heat water to 50° C. and insert the mixture of powders
Disperse using a Silverson high-shear mixer (30 min, 50° C., 3500 RPM)
Heat the oil to 50° C. in a separate container, add to the aqueous dispersion and disperse using a Silverson high-shear mixer (5 min, 10,000 RPM)
Thermal treatment at 142° C. during 5 seconds
High-pressure homogenization 200 bars, 2 passes
Cool to 30° C.

Then the different beverages are compared by analyzing the particle size profile of the emulsion obtained in the beverage using a Mastersizer 3000 (Malvern) particle size analyzer, measuring the particle size by laser diffraction. The sample is measured directly in liquid with an optical pattern at 1.50+0.01i. The D10, D50, D90 and Dmode coefficients, well known to the skilled person, are measured to characterize the oil emulsion.

| | D10 (in | D50 (in | D90 (in | Dmode (in |
|---|---|---|---|---|
| | microns) | microns) | microns) | microns) |
| Field bean RTD | 0.183 | 0.415 | 1.13 | 0.392 |
| Pea RTD | 0.459 | 1.78 | 7.37 | 2.17 |

Comparing the results, it is clear that the emulsion obtained with the field bean isolate according to the invention is much smaller, indicating a better emulsion.

### Example 6: Plant Milk or “Milk Alternative”

It is proposed here to make a plant milk with the field bean isolate 2a according to the invention.

The recipe is as follows:

| Ingredients | % |
|---|---|
| Water | 92.00 |
| Cane sugar | 2.80 |
| Sunflower oil | 1.50 |
| Field bean isolate according to example 2a | 3.70 |

The preparation protocol is as follows:
Heat the water to 70° C. and hydrate the protein isolate during 15 min using a Sylverson at 2000 RPM
Add the other ingredients except for the oil and mix for 10 min
Heat the oil to 65° C. and add while stirring at 6000 RPM
UHT sterilization at 142° C. for 5 sec
Homogenization at 75° C., 2 stages (270 bars and 30 bars)
Cool to 4° C.

The result is a liquid with the appearance of milk. This plant-based milk alternative does not undergo any decanting during storage.

The particle size distribution of the emulsified oil globules is analyzed using a Mastersizer 3000 (Malvern) particle size analyzer. The coefficients that describe the particle size distribution are as follows: D10'20.19_microns, D50=0.40 microns and D90=0.91 microns. These results are excellent and clearly show an excellent emulsification of the lipid globules, just like milk.

### Example 7: Regular and Light Mayonnaise

We will demonstrate below the excellent results of our isolate 2a according to the invention in the production of regular mayonnaise (called “full-fat”) and light mayonnaise (called “low-fat”).

The ingredients needed to make the mayonnaise recipes are as follows:

| | |
|---|---|
| “Full-fat” recipe | “Low-Fat” recipe |

Ingredients for 1st phase

| Drinking water | 10.58% | 53.78% |
|---|---|---|
| Mustard | 2.50% | 2.50% |
| Sucrose | 4.50% | 4.50% |
| NaCl | 1.00% | 1.00% |
| Protein isolate to be tested | 0.80% | |
| Potassium sorbate | 0.12% | 0.12% |

Ingredients for 2nd phase (dispersion in the oil)

| | | |
|---|---|---|
| Sunflower oil | 70.00% | 25.00% |
| PREGEFLO CH40 pregelatinized | | 4.00% |
| starch (ROQUETTE) | | |
| Xanthan gum | | 0.30% |

Ingredients for 3rd phase (acid)

| | | |
|---|---|---|
| White vinegar | 5.50% | 5.50% |
| Lemon juice | 2.50% | 2.50% |

Ingredients for 4th phase (oil)

| | |
|---|---|
| Sunflower oil | 2.50% |

The isolates to be tested are Nutralys® F85F by the company ROQUETTE, the field bean isolate 2a according to the invention and aquafaba (“Aquafaba Powder” obtained from the company Vor).

The manufacturing protocol is as follows:
Mix the ingredients for the 1st phase during 1 min at speed 3 in a HOTMIX Pro Gastro (manufacturer: MATFER—FLO, model: 212502).
Add the ingredients for the 2nd and 3rd phase during 1:30 min at a speed between 4 and 7 for Low Fat or add the ingredients for the 2nd phase during 2 min at speed 3 for Full Fat.
Add the ingredients for the 3rd phase during 1 min at speed 3 for Full Fat.
Add the ingredients for the 4th phase during 1 min at speed 3 for Full Fat.
Finish the emulsion at speed 8 for Low Fat and 3 for Full Fat during 1 min.

The different mayonnaises obtained are compared using a TA.HDplus texture analyzer (company Stable Micro Systems Ltd), allowing us to measure the parameters of firmness, consistency and cohesion. The firmness (g) corresponds to the force to be applied so that the geometry (cf. “extrusion ring backward” kit described hereunder) penetrates into the product, the consistency (g.sec) is a data item calculated according to the area under the curve of the firmness and the cohesion (g) corresponds to the force to be applied so that the geometry withdraws from the mayonnaise.

The texture analyzer is equipped with the “extrusion ring backward” kit which is made up of a disc screwed onto the apparatus and 3 plexiglass containers, which are filled with the mayonnaise. The acquisition is carried out using the Exponent software with the program designed to analyze mayonnaises. The geometry is lowered at 3 mm/s until it reaches the bottom of the container and it is raised at 5 mm/s. The software automatically draws a curve based on time making it possible to deduce the parameters thereof.

The entire implementation is clearly explained in the instruction manual.

The results for “low-fat” mayonnaise are as follows:

| | Firmness | Consistency | Cohesion |
|---|---|---|---|
| | (g) | (g/sec) | (g) |
| Aquafaba | 461 | 12,361 | −594 |
| Nutralys F85F | 416 | 11,027 | −530 |
| Protein isolate according to the | 564 | 14,695 | −724 |
| invention | | | |
| Egg mayonnaise | 491 | 13,371 | −617 |

The results for “full-fat” mayonnaise are as follows:

| | Firmness | Consistency | Cohesion |
|---|---|---|---|
| | (g) | (g/sec) | (g) |
| Nutralys F85F | 235 | 5,055 | −245 |
| Protein isolate according to the | 528 | 13,575 | −570 |
| invention | | | |
| Egg mayonnaise | 358 | 9,791 | −489 |

The results obtained show that the mayonnaises obtained with the field bean isolate according to the invention are characterized by excellent texture values, far superior to the pea isolate or aquafaba.

### Example 9: Ice Creams

A NUTRALYS® pea protein isolate is compared with the field bean isolate according to the invention in an ice cream recipe.

The different ice cream compositions are as follows:

| | | Field bean isolate |
|---|---|---|
| | | 2a according to the |
| | NUTRALYS S85F | invention |
| | % | % |
| Drinking water | 63.1 | 63.41 |
| Sucrose | 12 | 12 |
| Hydrogenated coconut oil | 8 | 8 |
| Cremodan SE 30 (stabilizer) | 0.25 | 0.25 |
| Roquette 6080 glucose syrup | 11.5 | 11.5 |
| NUTRALYS ® S85F | 3.15 | 0 |
| NUTRIOSE ® FM 10 | 2 | 2 |
| Field bean isolate | 0 | 2.84 |
| according to the invention | | |

The preparation protocol is as follows:
Heat the water to 60° C.
Add and mix water and ¾ of the sucrose during 5 minutes
Add stabilizer and the rest of the sucrose mixing during 5 min
Add the isolate to be tested, mix during 5 min
Add the coconut oil, mix during 5 min
Final mixing during 20 min at 60° C.
High-pressure homogenization at 70° C., 200 bars
Pasteurization at 80° C. for 3 min in a Powerpoint®
Cool to 4° C.
Ripening overnight in the refrigerator
Freezing with Tetrapak freezer, targeting 100% overrun

The efficiency of whipping on the mixture obtained just before pasteurization is compared. The protocol used is as follows:
Pour 1 liter of the mixture into the bowl of a Kitchenaid®
Mix at high speed (10) during 6 minutes and pour into a 2 liter test jar
Immediately measure the volume of the mixture and foam at T0
Measure again after 15 min

The results obtained are as follows:

| | | Isolate according to |
|---|---|---|
| | Nutralys S85F | the invention |
| Volume of mixture at T0 | 1500 ml | 1500 ml |
| Volume of foam at T0 | not visible | not visible |
| Volume of mixture at T15 | 1400 ml | 1500 ml |
| Volume of foam at T15 | 700 ml | not visible |

For the mixture obtained with the isolate according to the invention, the foam is invisible from the start until 15 min. This is explained by better retention in the mixture containing the isolate according to the invention. This better-retained foam makes it possible to obtain an ice cream that is more uniformly whipped.

### Example 10: Gelling at Acid pH

Gelling at acid pH is an important property, in particular during the production of yoghurts, as well as tofu.

A comparative gel strength analysis of pea and field bean isolates is performed using the TAXT+ texture analyzer after thermal treatment and acidification with glucono-delta-lactone (GDL).

The powders are hydrated to 15% of solids in azide water, placed in a double boiler at 60° C., while stirring during 5 minutes. The solutions are then left stirring, at ambient temperature, overnight. The next day, GDL is added in a proportion of 2% by weight. Immediately after adding, each solution is distributed in 3 separate pots (in order to triple the gelling force measurements). Acidification is carried out in order to reach a pH of 4.6. The samples are placed in a double boiler at 80° C. during 2 h, before being stored overnight in the refrigerator. The gelling force measurements are then taken the next day.

The characterizations of the gel were carried out at 20° C., with a TAXT+ texture analyzer from the company Stable Micro Systems Ltd. The parameters are as follows compression mode, geometry: ball punch P0.5S, pre-test speed: 1 mm/sec, test speed: 0.5 mm/sec, post-test speed: 10 mm/sec, distance: 15 mm, hold time: 60 sec, trigger force: 5 g. The force necessary for applying this movement is registered and the maximum force required is retained.

The results are as follows:

| | Maximum force |
|---|---|
| | (in g) |
| Field bean isolate 2a according to the invention | 143.9 |
| NUTRALYS ® S85F | 47 |

It is clearly seen that with the isolate according to the invention, a gelling force 3 times greater than that of the pea protein isolate is obtained. This observation makes it possible to foresee excellent results when manufacturing fermented products that are alternatives to yoghurts, spoonable or drinkable. For the spoonable products, the excellent gelling force makes it possible to foresee formulations without hydrocolloids such as pectin.

### Example 11: Yoghurts

A Nutralys® S85F pea protein isolate from the company Roquette is compared with the field bean isolate 2a according to the invention.

The formulations of the yoghurts are as follows:

| | Yoghurt with | Yoghurt with field |
|---|---|---|
| | Nutralys ® S85F | bean protein isolate |
| | pea protein | 2a according to the |
| | isolate | invention |
| | % | % |
| water | 88.78 | 89.05 |
| Sunflower oil | 2.60 | 2.75 |
| Cane sugar | 4.20 | 4.20 |
| NUTRALYS ® S85F | 4.42 | 0.00 |
| Field bean isolate according to | 0.00 | 4.00 |
| example 2a | | |

The preparation protocol is as follows:
Hydrate the isolates with water at 55° C. during 30 min with a Sylverson stirrer at 2500 RPM
Add the other ingredients and mix for 5 min at 6000 RPM
Homogenize at high pressure in two stages (150 bar and 45 bar) at 60° C.
Pasteurize at 95° C. for 10 min
Cool to 42° C. and add YOFLEX® YF-L02DA ferments
Keep at 42° C. to acidify by fermentation until obtaining pH 4.6
Homogenize at 4000 RPM with IKA Magic Lab
Store for 4 days at 4° C.

The firmness of the yoghurts obtained is compared using a TAXT+ texture analyzer. The results are as follows:

| Yoghurt | Firmness (g) |
|---|---|
| Pea base | 259 |
| Field bean base | 445 |

It can be clearly seen that yoghurts based on field bean isolates are firmer since the force necessary to perform the analysis is much greater.

1-15. (canceled)

16. A field bean protein composition the color of which comprises a component L greater than 70, preferably greater than 75, even more preferentially greater than 80 according to the measurement L*a*b and the water retention according to the test A is greater than 3 grams, preferentially greater than 3.5 grams of water per gram of isolate.

17. The protein composition according to claim 16, wherein its protein content is greater than 70% by weight expressed as a percentage of proteins on solids, preferentially greater than 80% by weight, even more preferentially greater than 90% by weight.

18. The protein composition according to claim 16, wherein it has a solids content greater than 80% by weight, preferentially greater than 85% by weight, even more preferentially greater than 90% by weight.

19. A method for producing the protein composition according to claim 16, comprising the following steps:
1) Using field bean seeds;
2) Grinding the field bean seeds by means of a stone mill, followed by separating the obtained ground material into two fractions referred to as light and heavy by means of an ascending air flow, followed by second grinding of the heavy fraction with a knife mill;
3) Finally grinding the heavy fraction by means of a mill selected from roller mills and knife mills to obtain a flour;
4) Suspending the flour in an aqueous solvent;
5) Removing the solid fractions from the suspension by centrifugation and obtaining a liquid fraction;
6) Isolating by precipitation by heating at the isoelectric pH of the field bean proteins contained in the liquid fraction;
7) Diluting the field bean proteins previously obtained to 15-20% by weight of solids and neutralizing the pH between 6 and 8, preferentially 7, to obtain the field bean protein composition;
8) Drying the field bean protein composition

20. The method according to claim 19, wherein the average particle size of the flour obtained in step 3 is between 200 and 400 microns, preferentially 300 microns.

21. The method according to claim 19, wherein the pH of the aqueous solvent during step 4 is adjusted between 8 and 10, preferentially 9.

22. The method according to claim 19, wherein the temperature of the aqueous solvent of step 4 is adjusted between 2° C. and 30° C., preferentially between 10° C. and 30° C., preferentially between 15° C. and 25° C., even more preferentially to 20° C.

23. The method according to claim 19, wherein the acidification of step 6 is carried out at a pH between 4 and 5, preferentially 4.5.

24. The method according to claim 19, wherein the heating temperature is between 45° C. and 75° C., preferentially between 50° C. and 70° C., even more preferentially between 55° C. and 65° C., the most preferred being 60° C. and the heating time is between 5 minutes and 25 minutes, preferentially between 10 and 20 minutes, the most preferred being 10 minutes.

25. The method according to claim 19, wherein step 7 also contains a thermal treatment, preferentially at a temperature of 135° C. by direct steam injection through a nozzle and flash vacuum cooling to 65° C.

26. The method according to claim 19, wherein step 8 also contains drying, preferentially by multiple-effect atomization.

27. The method according to claim 19, wherein steps 3 and 4 of the method are carried out concomitantly in order to perform the final grinding of the heavy fraction in the presence of aqueous solvent.

28. The method according to claim 27, wherein the pH of the aqueous solvent during the final grinding step of the heavy fraction in the presence of aqueous solvent is adjusted between 8 and 10, preferentially 9.

29. An industrial use, in particular in human or animal nutrition, in cosmetics, in pharmacy, of a field bean protein composition comprising a component L greater than 70, preferably greater than 75, even more preferentially greater than 80 according to the measurement L*a*b and the water retention according to the test A is greater than 3 grams, preferentially greater than 3.5 grams of water per gram of isolate or obtained by the method according to claim 19.

30. The use according to claim 29 in:
beverages, in particular beverages for dietary or clinical nutrition, enteral beverages or bags, plant beverages,
fermented milks such as yogurts,
plant creams,
dessert creams,
frozen desserts or sorbets,
biscuits, muffins, pancakes,
nutritional bars for dietetic nutrition,
breads,
high-protein cereals,
cheeses,
meat analogues,
fish analogues,
sauces, in particular mayonnaise.
